(19) United States
(12) Patent Application Publication
(10) Pub. No.: US 2021/0295240 A1
(43) Pub. Date: Sep. 23, 2021

(54) INFORMATION PROCESSING APPARATUS AND EVALUATION SUPPORT METHOD

(71) Applicant: FUJITSU LIMITED, Kawasaki-shi (JP)

(72) Inventor: Shoji HAYAKAWA, Akashi (JP)

(73) Assignee: FUJITSU LIMITED, Kawasaki-shi (JP)

(21) Appl. No.: 17/163,591

(22) Filed: Feb. 1, 2021

(30) Foreign Application Priority Data
Mar. 23, 2020 (JP) 2020-051815

(51) Int. Cl. G06Q 10/06

(52) U.S. Cl. CPC G06Q 10/063116; G06Q 10/06316

(57) ABSTRACT

A non-transitory computer-readable recording medium having stored an evaluation support program that causes a computer to perform a process, the process includes acquiring load information that indicates a load of a subject; acquiring information of an active window of an information processing apparatus on which the subject is working, classifying a type of work, based on the acquired information of the active window, and storing a classification result of the classifying of the type of work, the acquired load information, and time information that indicates acquisition time of the load information in association with each other as information related to a work evaluation of the subject.

### CROSS-REFERENCE TO RELATED APPLICATION

This application is based upon and claims the benefit of the prior Japanese Patent Application No. 2020-051815 filed on Mar. 23, 2020, the entire contents of which are incorporated herein by reference.

### FIELD

The embodiments discussed herein are related to an information processing apparatus an evaluation support method.

### BACKGROUND

In the related art, in order to improve the work efficiency, biometric information is acquired from a sensor worn by an employee (subject), and the load on the subject on the work is evaluated from the acquired biometric information.

Regarding the evaluation of work, a technique is known in which the biometric information acquired from the sensor of the subject is stored in association with a schedule including an event schedule in a storage unit and the state of the autonomic nerve is evaluated from the stored information. In addition, a technique is known in which work load values of a plurality of people corresponding to the same scene information are compared, and it is determined whether a work load for a person is higher than a predetermined condition.

Related technologies are disclosed in, for example, Japanese Laid-open Patent Publication Nos. 2019-004924, 2019-195427, and 2019-030389 and International Publication Pamphlet No. WO 2017/187666.

### SUMMARY

According to an aspect of the embodiments, a non-transitory computer-readable recording medium having stored an evaluation support program that causes a computer to perform a process, the process includes acquiring load information that indicates a load of a subject; acquiring information of an active window of an information processing apparatus on which the subject is working, classifying a type of work, based on the acquired information of the active window, and storing a classification result of the classifying of the type of work, the acquired load information, and time information that indicates acquisition time of the load information in association with each other as information related to a work evaluation of the subject.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a configuration example of an evaluation system according to a first embodiment;

FIG. 2A is a flowchart illustrating an example of processing related to acquisition of stress data;

FIG. 2B is a flowchart illustrating an example of processing related to acquisition of work data;

FIG. 3 is an explanatory diagram illustrating an example of stress data;

FIG. 4 is an explanatory diagram illustrating an example of an active window;

FIG. 5 is a flowchart illustrating an example of processing related to tagging acquired data;

FIG. 6A is an explanatory diagram illustrating a calculation example of a representative value of a stress value;

FIG. 6B is an explanatory diagram illustrating a calculation example of a representative value of a stress value;

FIG. 6C is an explanatory diagram illustrating a calculation example of a representative value of a stress value;

FIG. 7A is an explanatory diagram illustrating an example of a rule dictionary;

FIG. 7B is an explanatory diagram illustrating an example of a rule dictionary;

FIG. 8 is a flowchart illustrating an example of processing related to displaying of evaluation;

FIG. 9A is an explanatory diagram illustrating a display example of an evaluation result;

FIG. 9B is an explanatory diagram illustrating a display example of an evaluation result;

FIG. 10 is a block diagram illustrating a configuration example of an evaluation system according to a second embodiment;

FIG. 11A is a flowchart illustrating an example of processing related to acquisition of stress data;

FIG. 11B is a flowchart illustrating an example of processing related to tagging work data;

FIG. 12 is a flowchart illustrating an example of processing related to data storage in a database; and

FIG. 13 is a block diagram illustrating an example of a computer configuration.

### DESCRIPTION OF EMBODIMENTS

In the related art, in order to obtain an evaluation result for work, it may be burdensome to manually set the information indicating the work content such as the schedule and the scene information associated with the biometric information.

Hereinafter, embodiments of a technique that may support an easy evaluation of work on the subject will be described with reference to the accompanying drawings. In the embodiments, components having the same function will be denoted by the same reference numeral, and overlapping descriptions thereof will be omitted. Further, the evaluation support program, the evaluation support method, and the information processing apparatus described in the following embodiments are merely examples, and do not limit the embodiments. In addition, the embodiments may be appropriately combined with each other within a range that does not cause any inconsistency.

### First Embodiment

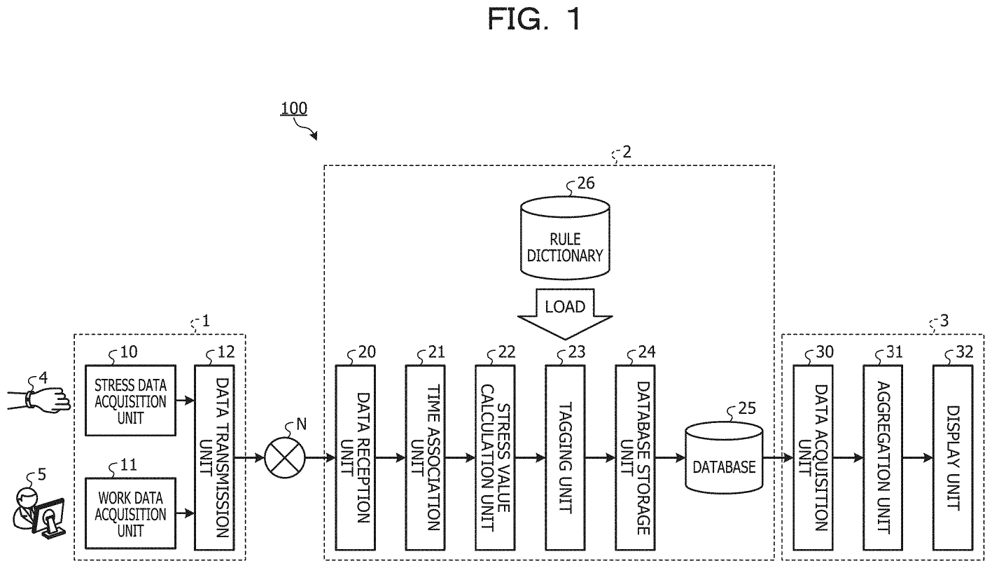

FIG. 1 is a view illustrating a configuration example of an evaluation system according to a first embodiment. As illustrated in FIG. 1, the evaluation system 100 includes a client terminal 1, a server 2, and an analyst terminal 3. The client terminal 1 and the server 2 are connected to each other so as to be able to communicate with each other via a network N such as a Local Area Network (LAN) or the Internet.

The client terminal 1 is, for example, a terminal device used by a subject 5, and a Personal Computer (PC) or the like is applicable. The client terminal 1 collects the biometric information (e.g., heart rate, blood pressure, respiratory rate, etc.) of the subject 5, that is, load information (hereinafter, stress data) indicating the physical load (stress) during work from a wearable device 4 worn by the subject 5. Further, an information processing apparatus (e.g., client terminal 1) such as a PC collects information (work data) of a window that is in an active state (hereinafter, referred to as an active window) where the subject 5 is working in front of the screen thereof. The client terminal 1 transmits the collected stress data and work data to the server 2 via the network N.

The server 2 acquires the stress data and the work data collected by the client terminal 1 from the subject 5 via the network N. The server 2 stores the stress data and the work data acquired from the client terminal 1 in a database 25 in association with the time information indicating time.

The analyst terminal 3 is a terminal device used by an analyst (e.g., a site supervisor) who evaluates (analyzes) the work of the subject 5, and a PC or the like is applicable. The analyst terminal 3 reads out the stress data and the work data associated with the time information stored in the database 25, and displays the aggregated result on a display or the like. With such features, the analyst evaluates the load for each work data of the subject 5.

Specifically, the client terminal 1 includes a stress data acquisition unit 10, a work data acquisition unit 11, and a data transmission unit 12.

The stress data acquisition unit 10 is a processing unit that collects the biometric information (e.g., heart rate, blood pressure, respiratory rate, etc.) of the subject 5, that is, the load information (hereinafter, referred to as stress data) indicating the physical load (stress) during work from the wearable device 4 worn by the subject 5. For example, the stress data acquisition unit 10 collects stress data such as the heart rate, blood pressure, and respiratory rate measured by the wearable device 4 via a wireless communication such as, for example, Bluetooth (registered trademark).

The work data acquisition unit 11 is a processing unit that collects information (work data) of an active window of an information processing apparatus (e.g., client terminal 1) such a PC where the subject 5 is working in front of the screen thereof. For example, the work data acquisition unit 11 collects work data related to the active window from the information processing apparatus on which the subject 5 is working via an Application Programming Interface (API) or the like. Specifically, the work data acquisition unit 11 collects information such as the title name of the active window and the name of an application that provides the active window as work data via the API.

The data transmission unit 12 is a processing unit that transmits data (e.g., stress data, work data, identification information (ID), and time information) collected by the stress data acquisition unit 10 and the work data acquisition unit 11 to 2 to the server 2 via the network N.

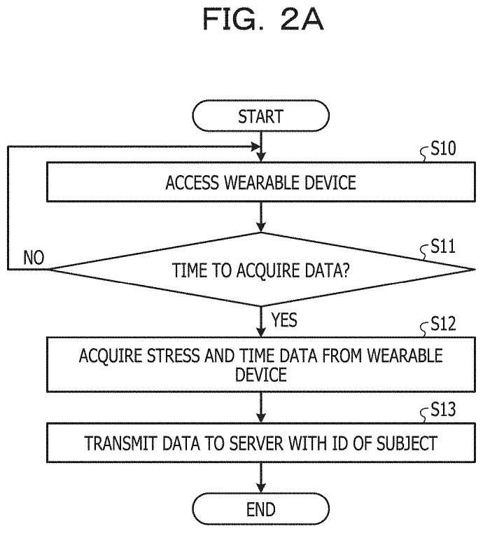

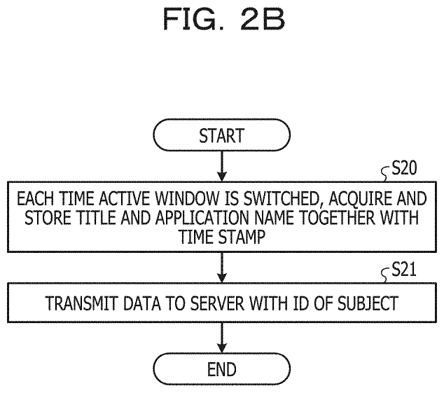

Here, the details of the operation of the client terminal 1 will be described with reference to FIGS. 2A and 2B. FIG. 2A is a flowchart illustrating an example of processing related to acquisition of stress data. FIG. 2B is a flowchart illustrating an example of processing related to acquisition of work data.

As illustrated in FIG. 2A, when a process related to the acquisition of stress data is started, the stress data acquisition unit 10 communicates with the wearable device 4 of the subject 5 via a wireless communication such as Bluetooth (registered trademark) (S10).

Next, the stress data acquisition unit 10 determines whether it is the time to acquire the data at a predetermined time interval (e.g., every 3 hours) (S11), and when it is determined that it is not the time to acquire the data (S11: NO), the stress data acquisition unit 10 waits for processing.

When it is determined that it is the time to acquire the data (S11: YES), the stress data acquisition unit 10 acquires the stress data and the time data indicating the measurement time of the stress data from the wearable device 4 (S12). Further, the above-mentioned “measurement time” is not the time when the server 2 acquires the stress data from the wearable device, but the time when the biometric information is measured in the wearable device at regular time intervals.

Next, the data transmission unit 12 transmits the acquired data (stress data and time data) to the server 2 with the identification information (ID) of the subject 5 preset in the memory or the like (S13), and ends the processing.

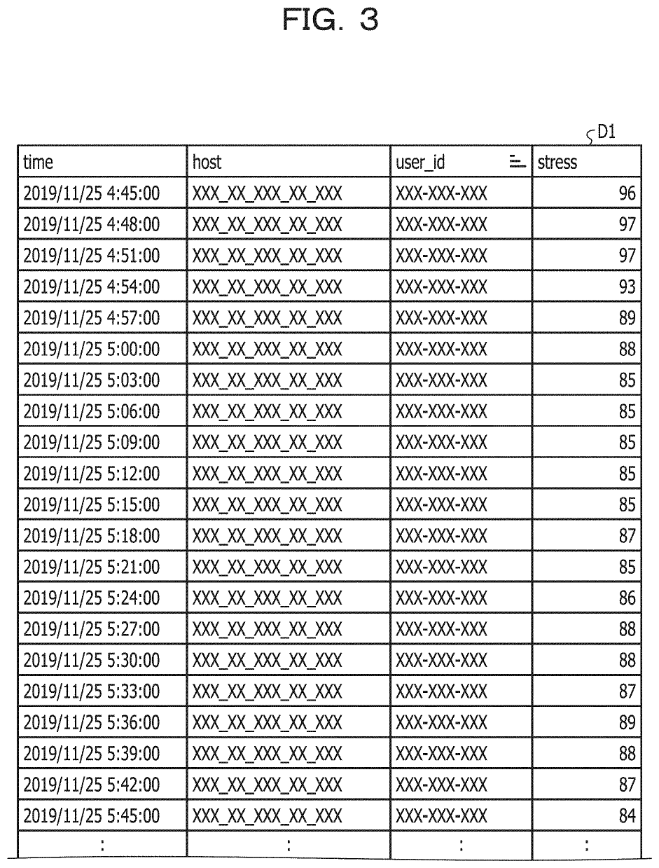

FIG. 3 is an explanatory diagram illustrating an example of stress data. As illustrated in FIG. 3, the stress data D1 transmitted to the client terminal 1 includes the time (time) when the stress data is acquired from the subject 5, the host name (host) of the client terminal 1, the identification information (user_id) of the subject 5, and the stress value.

As illustrated in FIG. 2B, when the process related to the acquisition of work data is started, the work data acquisition unit 11 collects information (work data) on the active window from the information processing apparatus on which the subject 5 is working via the API. Specifically, each time the active window is switched, the work data acquisition unit 11 acquires the title of the active window and the application name together with the time stamp, and stores such information in a memory or the like (S20). Further, when such information is stored in the memory, since data may be lost before the data is sent to the server 2 due to the restart of the client terminal 1, a database file may be created inside the client terminal 1 and sequentially store the data in the database.

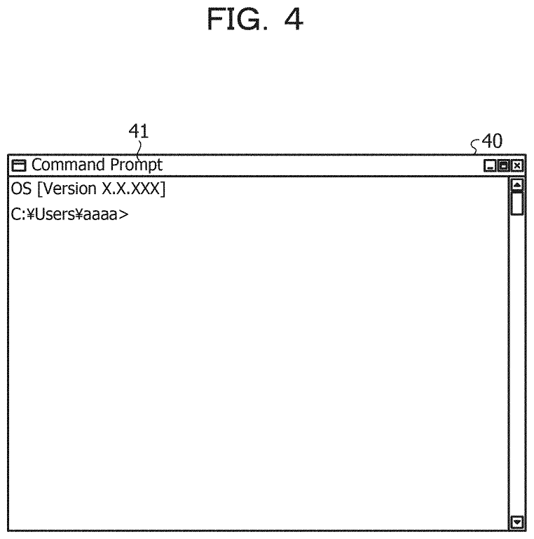

FIG. 4 is an explanatory view illustrating an example of an active window 40. As illustrated in FIG. 4, the work data acquisition unit 11 collects information on the active window 40 which is the front surface (foreground) on the screen in the information processing apparatus on which the subject 5 is working. Specifically, the work data acquisition unit 11 collects a title 41 such as “Command Prompt” in the active window 40 and an application name such as “command prompt.”

Next, the data transmission unit 12 transmits the work data related to the active window acquired/accumulated together with the time stamp to the server 2 with the identification information (ID) of the subject 5 preset in the memory or the like (S21), and ends the processing.

Referring back to FIG. 1, the server 2 includes a data reception unit 20, a time association unit 21, a stress value calculation unit 22, a tagging unit 23, a database storage unit 24, a database 25, and a rule dictionary 26.

The data reception unit 20 is a processing unit that receives data transmitted from the client terminal 1 by communication via the network N. Specifically, the data reception unit 20 includes stress data indicating the load of the subject 5 transmitted from the client terminal 1 and work data related to the active window of the information processing apparatus on which the subject 5 is working. That is, the data reception unit 20 is an example of an acquisition unit.

The time association unit 21 is a processing unit that associates the time in the data acquired from the client terminal 1. Specifically, the time association unit 21 refers to time information such as a time stamp given to the data, and associates the time between the data. As an example, the time association unit 21 compares the time in the stress data with the time stamp in the work data, and associates the data with the latest time with each other.

The stress value calculation unit 22 is a processing unit that calculates a representative value of the stress values in the same work data period (also referred to as work time) until the active window 40 is switched, with respect to the work data associated with the stress data by the time.

For example, the stress value calculation unit 22 aggregates the stress values in the work time of the same work data, and calculates the average value thereof as a representative value. Further, the stress value calculation unit 22 calculates a difference between the stress values at the start and the end (increase/decrease in the work in the same active window 40) in the work time of the same work data, as a representative value. Also, the stress value calculation unit 22 calculates the slope (regression coefficient) when the change in the stress value in the same work data period is linearly approximated, as a representative value. That is, the stress value calculation unit 22 is an example of a calculation unit.

The tagging unit 23 is a processing unit that classifies work types and tags the work with respect to the work data associated with the stress data by the time, based on the work data related to the active window.

Specifically, the tagging unit 23 refers to (loads) a rule dictionary 26 representing rules for classifying work types according to whether a predetermined keyword is included in the title name of the active window 40 and the application name related to the active window 40. Next, the tagging unit 23 adds a tag corresponding to the work type to the work data to be classified based on the rules conforming to the rule dictionary 26.

The database storage unit 24 is a processing unit that stores the classification result tagged by the tagging unit 23, the acquired stress data (e.g., the representative value calculated by the stress value calculation unit 22), and the time information indicating the time in the database 25 in association with each other. Specifically, in the record corresponding to the identification information of the subject 5, the database storage unit 24 stores the stress data of the subject 5, the tag corresponding to the type of work at the time of collecting the stress data, and the time information indicating the time at the time of collecting the stress data in the database 25 in association with each other. Also, the record may be stored in the database 25 as an entry consisting of a set of the work, identification information, time, stress representative value, and assigned tags, not for each record corresponding to the identification information.

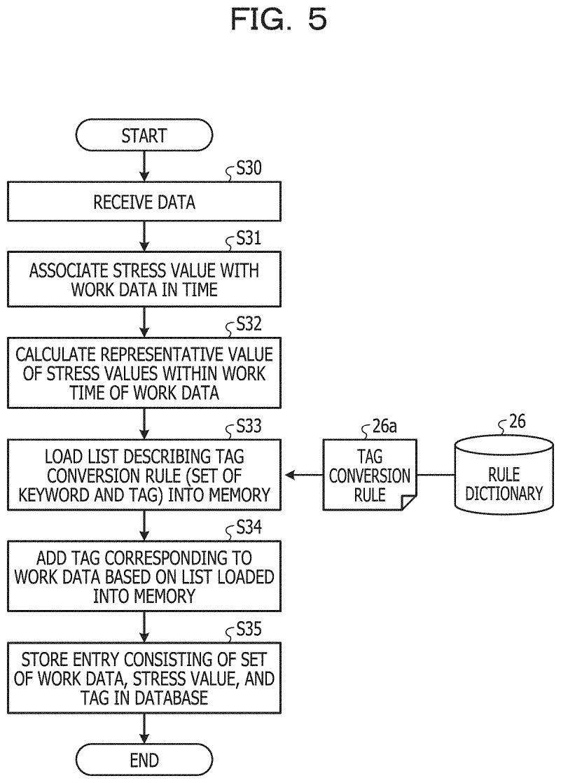

Here, the details of the operation of the server 2 will be described with reference to FIG. 5. FIG. 5 is a flowchart illustrating an example of processing related to tagging acquired data.

As illustrated in FIG. 5, when the processing is started, the data reception unit 20 receives data from the client terminal 1 (S30). Specifically, the data reception unit 20 receives stress data indicating the load of the subject 5 and work data related to the active window of the information processing apparatus on which the subject 5 is working.

Next, the time association unit 21 refers to time information such as a time stamp assigned to the data, and associates the stress value for each time in the stress data with the time in the work data (S31).

Next, the stress value calculation unit 22 calculates a representative value of the stress values within the work time of the same work data until the active window 40 is switched, with respect to the work data associated with the stress data by the time (S32).

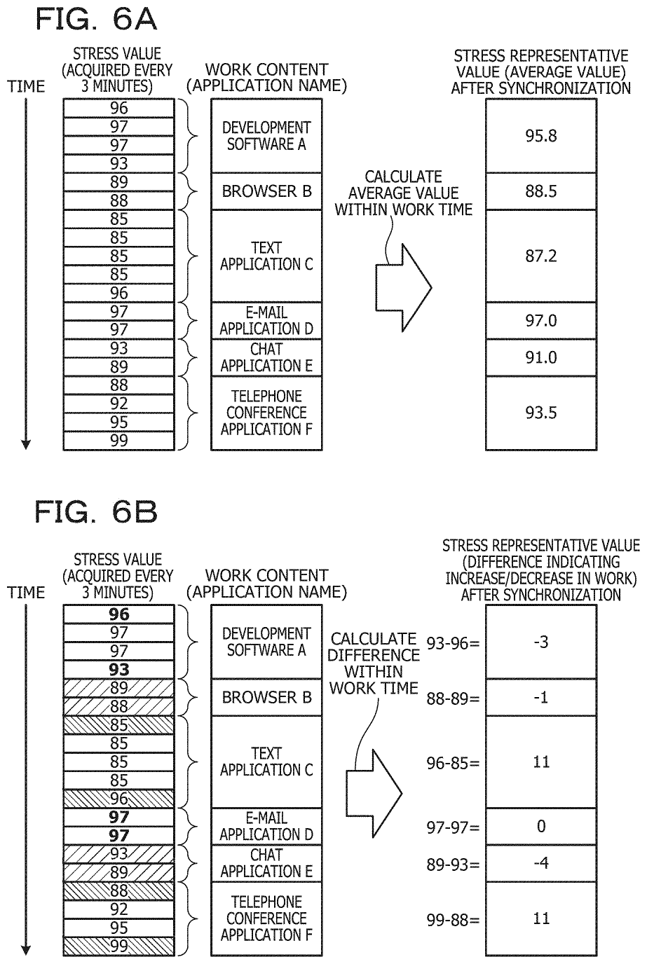

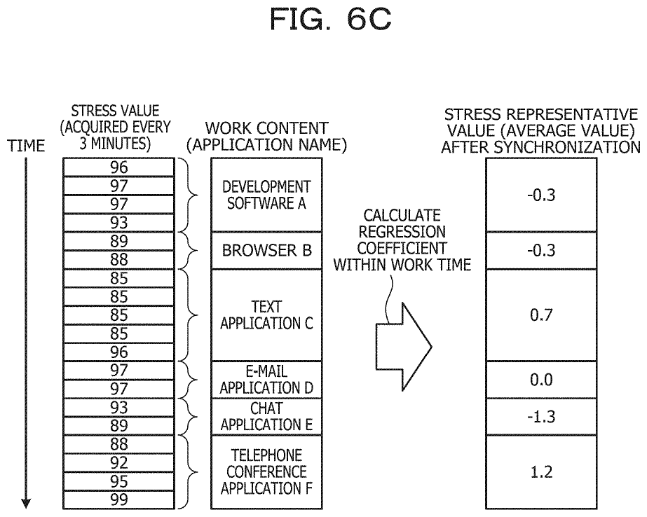

FIGS. 6A to 6C are explanatory views illustrating a calculation example of a representative value of the stress values. For example, as illustrated in FIG. 6A, the stress value calculation unit 22 aggregates the stress values for the same work time (e.g., “development software A,” “browser B,” . . . ) until the active window 40 is switched, and calculates the average value thereof as a representative value.

Further, as illustrated in FIG. 6B, the stress value calculation unit 22 calculates the difference between the stress values at the start and the end (increase/decrease in work in the same active window 40) for the same work time (e.g., “development software A,” “browser B,” . . . ) until the active window 40 is switched, as a representative value.

Further, as illustrated in FIG. 6C, the stress value calculation unit 22 calculates the slope (regression coefficient) when the change in the stress value within the work time is linearly approximated for the same work time (e.g., “development software A,” “browser B,” . . . ) until the active window 40 is switched, as a representative value.

The stress value calculation unit 22 may calculate the representative value by any of the above calculation methods, and may calculate the representative value by using, for example, any calculation method preset by an analyst or the like.

Next, the tagging unit 23 loads the list (a predetermined set of keywords and tags) describing a tag conversion rule 26a into the memory from the rule dictionary 26 in which the rules for classifying the work types are represented (S33). Next, the tagging unit 23 adds tags corresponding to the work data associated with each other based on the list loaded into the memory (S34).

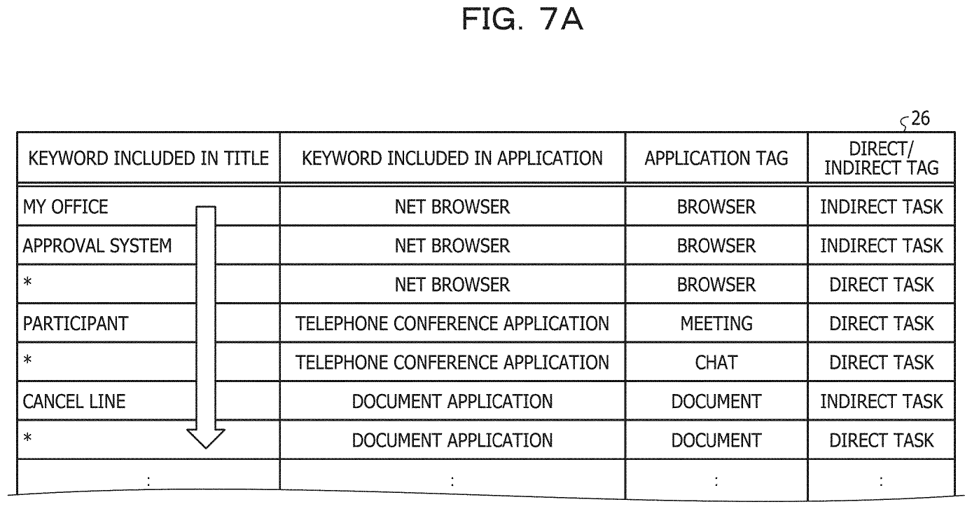

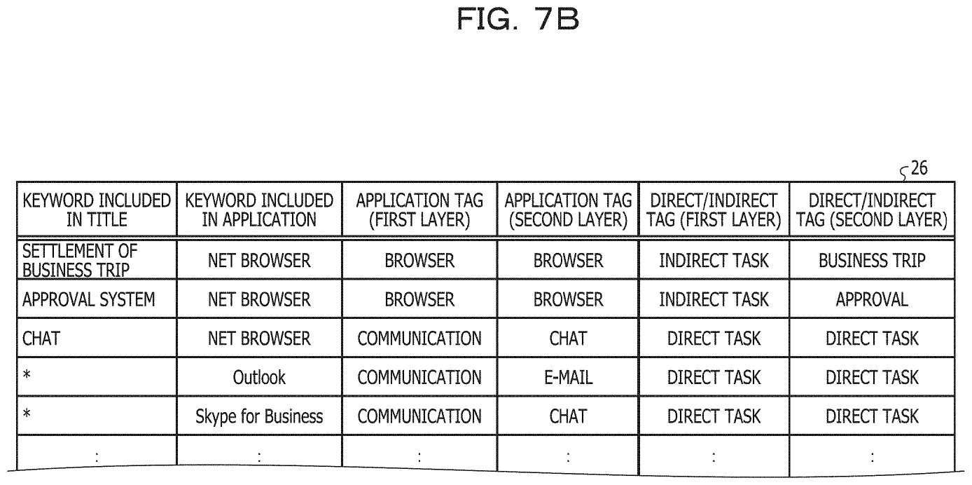

FIGS. 7A and 7B are explanatory diagrams illustrating an example of the rule dictionary 26. As illustrated in FIGS. 7A and 7B, the rule dictionary 26 is data of a list (dictionary) in which conversion rules related to tagging are described.

Specifically, as illustrated in FIG. 7A, the rule dictionary 26 represents rules for tags (e.g., application tags or direct/indirect tags) to be assigned according to the keywords included in the title 41 of the active window 40 and the keywords included in the application name related to the active window 40.

Further, the keyword “*” corresponds to an arbitrary character string. The “indirect task” in the direct/indirect tag is related to the work system and document whose installation and use are determined by the instruction according to the company's convenience. The “direct task” in the direct/indirect tag is related to all work that is not convenient for the company (excluding computer operation system related applications that are automatically started and executed unintentionally).

The tagging unit 23 scans the list of the rule dictionary 26 one by one in an order from the top, and specifies a list that satisfies the AND condition of the keywords included in the work data to be classified and the title 41, and the keywords included in the application name related to the active window 40. Next, the tagging unit 23 adds a tag (e.g., an application tag or a direct/indirect tag) included in the specified list as a tag corresponding to the work data.

For example, for the work data in which the title 41 of the active window 40 includes an “approval system” and the application name includes a “net browser,” the list in the second row from the top in the rule dictionary 26 satisfies the condition. Therefore, the tags “browser” and “indirect task” are added.

Further, when the work data includes the “net browser” in the application name, the list of “*” indicating an arbitrary keyword satisfies the condition even when no predetermined keyword matches in the title 41. Therefore, when the work data including the “net browser” in the application name does not match the predetermined keyword in the title 41, the tags “browser” and “direct task” are added.

Further, as illustrated in FIG. 7B, the rule dictionary 26 may indicate rules for assigning tags to each of a plurality of layers according to a combination of the keywords included in the title 41 and the keywords included in the application name related to the active window 40.

For example, the rule dictionary 26 represents a rule for assigning an application tag (first layer) indicating an outline of an application and an application tag (second layer) indicating details of the application to an application tag. Further, the rule dictionary 26 represents a rule for assigning a direct/indirect tag (first layer) indicating either “direct task” or “indirect task” and a direct/indirect tag (second layer) indicating the details of the work to the direct/indirect tag.

The tagging unit 23 scans the list of the rule dictionary 26 one by one in an order from the top, and specifies a list that matches the work data to be classified. The tagging unit may classify the work types into a plurality of layers and assign tags thereto. For example, the tagging unit 23 assigns more detailed tags of “business trip” and “approval” in the lower layer of the direct/indirect tag “indirect task.” By performing such tagging, it becomes possible to evaluate stress and work time in each of the “business trip” and the “approval” among the “indirect task.”

Next, the database storage unit 24 stores an entry in which the work data, the stress value, and the tag are combined for the record corresponding to the identification information of the subject 5 in the database 25 (S35), and ends the processing.

Referring back to FIG. 1, the analyst terminal 3 includes a data acquisition unit 30, an aggregation unit 31, and a display unit 32.

The data acquisition unit 30 is a processing unit that acquires the data entered in the database 25 of the server 2. Specifically, the data acquisition unit 30 acquires data for each assigned tag, data for each subject 5 based on the identification information of the subject 5, and the like from the database 25.

The aggregation unit 31 is a processing unit that aggregates the data entered in the database 25. Specifically, the aggregation unit 31 aggregates the data entered in the database 25 under the conditions (e.g., for each tag, for each subject 5, etc.) designated by the analyst via the UI (User Interface) or the like.

The display unit 32 is a processing unit that displays the aggregation result of the aggregation unit 31 on the display. Specifically, the stress evaluation results which are aggregated for each tag and for each subject 5, as an example, by the aggregation unit 31 are displayed on the display.

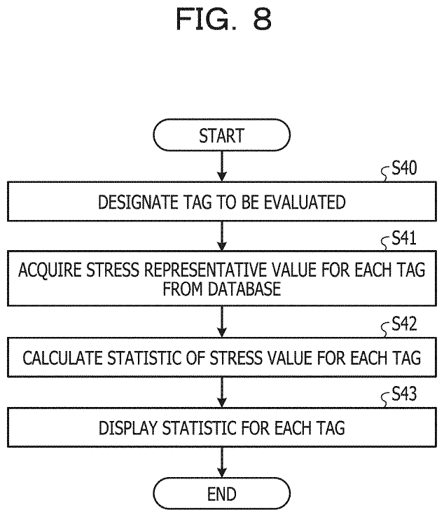

FIG. 8 is a flowchart illustrating an example of processing related to displaying of evaluation. As illustrated in FIG. 8, the analyst terminal 3 accepts the designation of the tag to be evaluated by the analyst via the UI or the like (S40).

Next, the data acquisition unit 30 acquires stress data (i.e., representative value) from the database 25 for each designated tag (S41). Next, the aggregation unit 31 calculates a statistic (e.g., an average value for each tag) for the stress value acquired for each tag (S42). Next, the display unit 32 displays the statistic calculated for each tag on the display (S43). Further, after all data is acquired from the database 25 and stored in the memory of the analyst terminal 3, the statistic for each designated tag may be calculated.

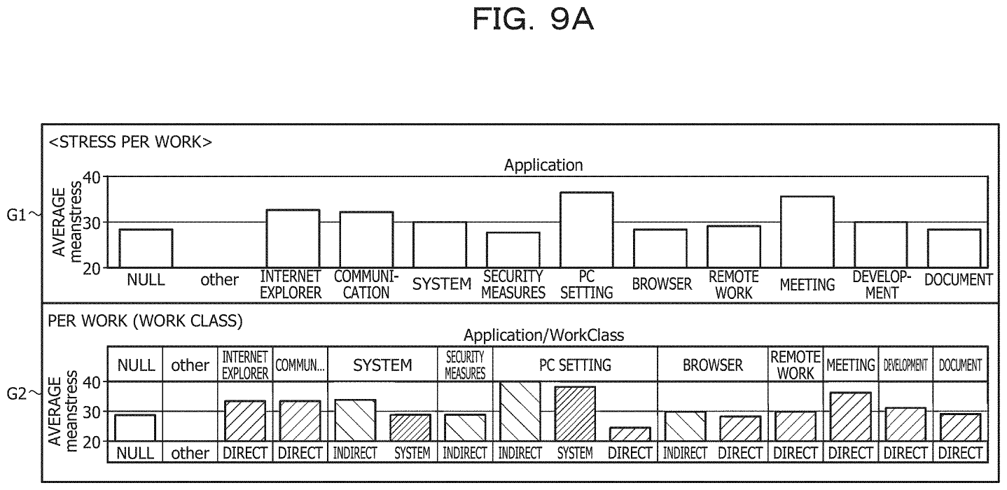

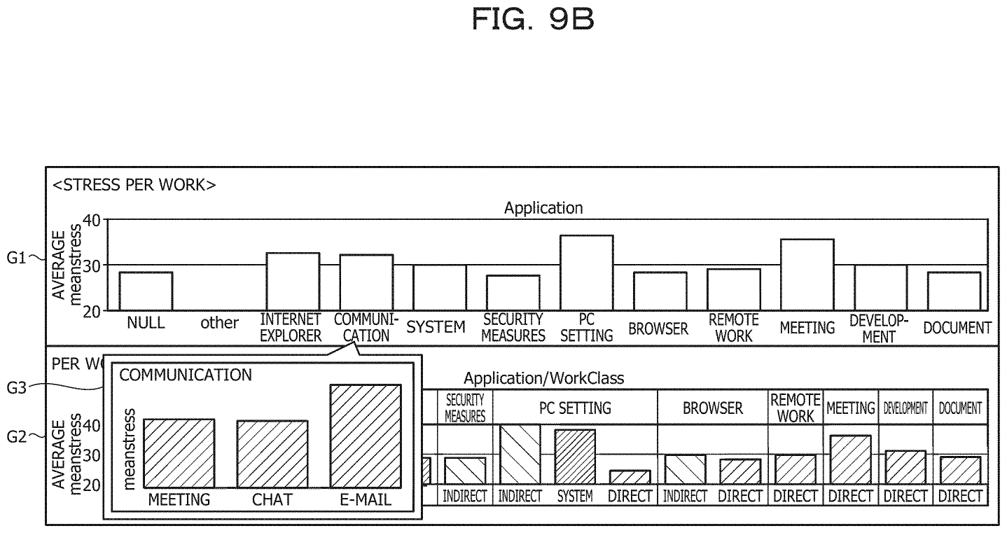

FIGS. 9A and 9B are explanatory views illustrating a display example of the evaluation result. As illustrated in FIG. 9A, the analyst terminal 3 displays the statistics calculated for each tag as the evaluation results G1 and G2 on the display. Specifically, the evaluation result G1 is a statistic related to the stress of the subject 5 for each working application indicated by the application tag. In addition, the evaluation result G2 is a statistic related to the stress of the subject 5 for each direct/indirect tag (e.g., “indirect task,” “direct task,” etc.) in each application. Further, in the evaluation result G2, there is a “system” in addition to the “indirect task” and the “direct task.” However, this represents work data that is exceptionally classified as a “system” because it is not appropriate to make computer operation system-related applications that are automatically started and executed unintentionally a “direct task.” This allows the analyst to evaluate the stress of the subject 5 in each work. For example, when setting up a personal computer as an indirect task, it may be seen that the stress is higher than other work.

Further, as illustrated in FIG. 9B, the analyst terminal 3 may display the details of the evaluation as a breakdown G3 according to the instruction of the analyst (e.g., a click operation) for the predetermined evaluation contents in the evaluation results G1 and G2. For example, in response to the selection operation of “communication” in the evaluation result G1, the analyst terminal 3 may display the details of “communication” (e.g., the breakdown of the lower layer (application tag (second layer))) as the breakdown G3. This allows the analyst to confirm in which work stress is increasing in the details in the application of “communication.”

### Second Embodiment

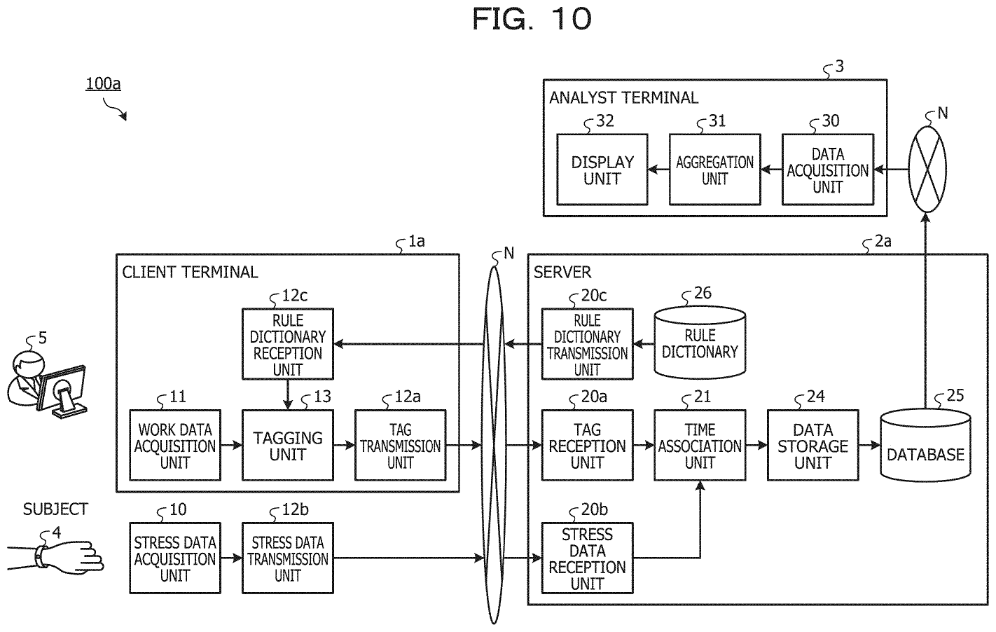

FIG. 10 is a block diagram illustrating a configuration example of an evaluation system according to a second embodiment. As illustrated in FIG. 10, the second embodiment is different from the first embodiment in that a client terminal 1a receives data related to the rule dictionary 26 from a server 2a and tags the work data. The second embodiment is also different from the first embodiment in that the stress data is directly transmitted from the wearable device 4 to the server 2a.

Specifically, the wearable device 4 includes a stress data acquisition unit 10 and a stress data transmission unit 12b. The stress data transmission unit 12b transmits the stress data acquired by the stress data acquisition unit 10 to the server 2a via the network N after adding the identification information of the subject 5.

The client terminal 1a includes a work data acquisition unit 11, a rule dictionary reception unit 12c, a tagging unit 13, and a tag transmitting unit 12a. The rule dictionary reception unit 12c receives data related to the rule dictionary 26 from the server 2a. The tagging unit 13 tags the work data in the same manner as the tagging unit 23. The tag transmission unit 12a transmits the tagged work data to the server 2a.

The server 2a includes a rule dictionary transmission unit 20c, a tag reception unit 20a, a stress data reception unit 20b, a time association unit 21, a database storage unit 24, a database 25, and a rule dictionary 26.

The tag reception unit 20a receives the tagged work data from the client terminal 1a. The stress data reception unit 20b receives stress data from the wearable device 4. The rule dictionary transmission unit 20c transmits data related to the rule dictionary 26 (a list of rules for classifying work types) to the client terminal 1a.

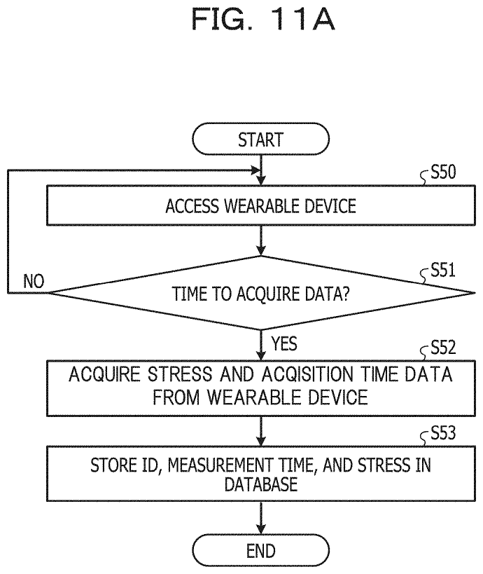

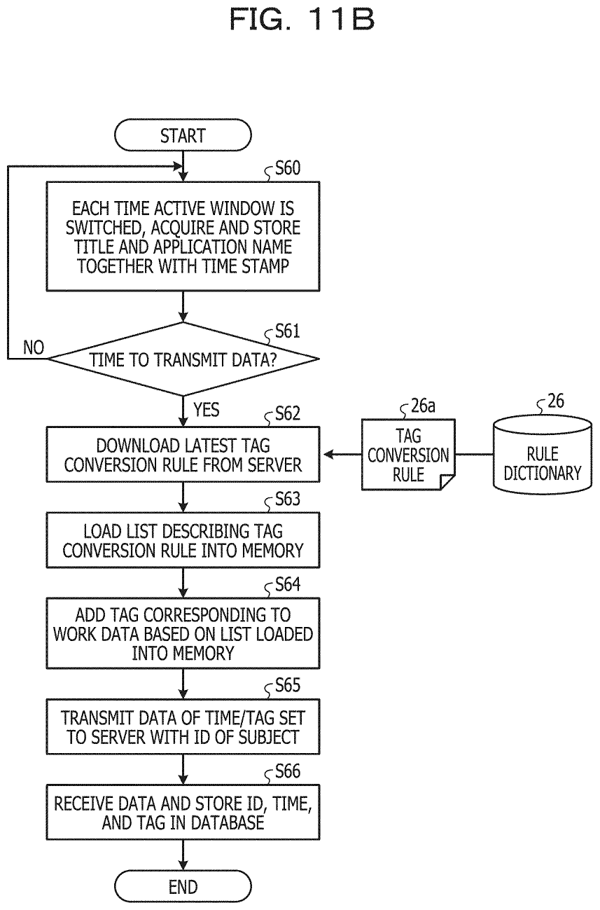

FIG. 11A is a flowchart illustrating an example of processing related to the acquisition of stress data. As illustrated in FIG. 11A, when the processing is started, the stress data reception unit 20b communicates with the stress data transmission unit 12b of the wearable device 4 via the network N (S50).

Next, the stress data reception unit 20b determines whether it is the time to acquire the data at a predetermined time interval (e.g., every 10 seconds) (S51), and when it is determined that it is not the time to acquire the data (S51: NO), the stress data reception unit 20b waits for processing.

When it is determined that it is the time to acquire the data (S51: YES), the stress data reception unit 20b acquires the stress data and time data indicating the acquisition time of the stress data from the wearable device 4 (S52).

The data transmission unit 12b stores the acquired data (the identification information (ID), time, and stress data of the subject 5) in the database 25 (S53), and ends the processing.

FIG. 11B is a flowchart illustrating an example of processing related to tagging work data. As illustrated in FIG. 11B, when the processing is started, each time the active window is switched, the work data acquisition unit 11 acquires the title of the active window and the application name together with the time stamp, and stores such information in the memory or the like (S60).

Next, for example, the tagging unit 13 of the client terminal 1a determines whether it is the preset data transmission time (S61). When it is determined that it is not the preset data transmission time (S61: NO), the client terminal 1a waits for processing.

When it is determined that it is the preset data transmission time (S61: YES), the rule dictionary reception unit 12c downloads the latest tag conversion rule 26a from the server 2a via the rule dictionary transmission unit 20c (S62).

Next, the tagging unit 13 loads the list (e.g., a predetermined set of keywords and tags) describing the tag conversion rule 26a into the memory (S63). Then, the tagging unit 13 adds a tag corresponding to the work data stored together with the time stamp based on the list loaded into the memory (S64).

Next, the tag transmission unit 12a transmits the data (work data) of a set of time and tag to the server 2a with the identification information (ID) of the subject 5 (S65).

The tag reception unit 20a of the server 2a receives the data from the client terminal 1a and stores the ID, the time, and the tag in the database 25 (S66).

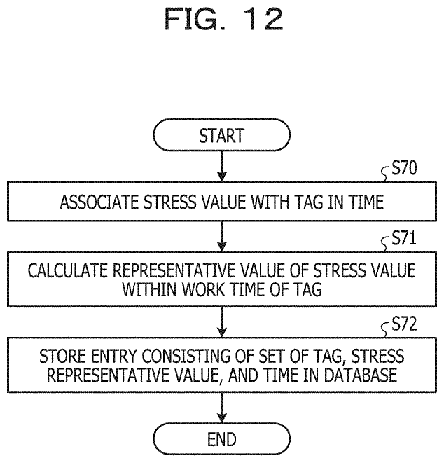

FIG. 12 is a flowchart illustrating an example of processing related to data storage in the database 25. As illustrated in FIG. 12, when the processing is started, the time association unit 21 associates the stress value for each time in the stress data received from the wearable device 4 with the tag of the work data received from the client terminal 1a by the time (S70).

Next, the stress value calculation unit 22 calculates a representative value of the stress values within the work time of the tag with respect to the stress data associated with the tag of the work data by the time (S71).

Next, the database storage unit 24 stores an entry in which the tag, the stress value (representative value), and the time are combined in the record corresponding to the identification information of the subject 5 in the database 25 (S72), and ends the processing.

As described above, the tagging may be performed on the client terminal 1, not the server 2. Further, the stress data may be directly transmitted to the server 2 without going through the client terminal 1.

As described above, in the evaluation system 100, for example, the server 2 includes a data reception unit 20, a tagging unit 23, and a database storage unit 24. The data reception unit 20 acquires, from the client terminal 1, the load information (stress data) which is the biometric information of the subject 5 indicating the load of the subject 5. Further, the data reception unit 20 acquires, from the client terminal 1, information (e.g., a title, an application name) of the active window 40 of the information processing apparatus (e.g., the client terminal 1) on which the subject 5 is working. The tagging unit 23 performs tagging indicating the work type of the subject 5 based on the acquired information of the active window 40, and classifies the work type. The database storage unit 24 stores the classification result of the tagging unit 23, the acquired stress data, and the time information indicating the acquired time in association with each other in the database 25, as information related to the work evaluation of the subject 5.

In this way, the evaluation system 100 does not involve the burden of manually setting the work content, and the work load information acquired from the subject 5 for each time is classified (tagged) according to the type of work and stored in the database 25. Therefore, an analyst (e.g., a site supervisor) who evaluates (analyzes) the work of the subject 5 may easily perform a multifaceted analysis (evaluation) of the work content, such as an analysis for each work content based on the data stored in the database 25.

Further, the tagging unit 23 classifies the types of work based on the keywords included in the information of the active window 40 (e.g., by referring to the rule dictionary 26). Therefore, in the evaluation system 100, the types of work may be classified by the keywords included in the title 41 of the active window 40 on which the subject 5 is working.

Further, the tagging unit 23 classifies the type of work based on the type of application related to the active window 40 (e.g., by referring to the rule dictionary 26). Therefore, in the evaluation system 100, the type of work may be classified according to the type of application related to the active window 40 on which the subject 5 is working.

Further, the tagging unit 23 classifies the work types into a plurality of layers based on a combination of the keywords included in the information of the active window 40 and the application types related to the active window 40 (see, e.g., FIG. 7B). Therefore, in the evaluation system 100, the type of work may be classified into a plurality of layers according to a combination of the keyword included in the title 41 of the active window 40 on which the subject 5 is working and the type of application related to the active window 40 on which the subject 5 is working.

Further, the data reception unit 20 acquires the information of the active window 40 after switching that has been made according to the switching of the active window 40 from the client terminal 1. The database storage unit 24 stores the classification result based on the information of the active window 40 after switching, the stress data acquired during the period (work time) from the active window 40 after switching to the next active window 40, and the acquired time information of the period in the database 25 in association with each other. Therefore, in the evaluation system 100, each time the active window 40 is switched, the work is classified (tagged) based on the information of the active window 40, and the stress data of the work time until the next switching is stored in the database 25 together with the classification result.

Further, for example, the server 2 further includes a stress value calculation unit 22 for calculating a representative value of stress data (stress values) included in the period until the active window 40 is next switched. The database storage unit 24 stores the classification result, the representative value calculated by the stress value calculation unit 22, and the time information of the acquired work time in association with each other in the database 25. Therefore, in the evaluation system 100, the representative value of the stress values in the work time is stored in the database 25 together with the classification result of the work in the work time from the switching of the active window 40 to the next switching. As a result, the analyst may perform the analysis using the representative value of the stress data within the work time of the same work type from the switching of the active window 40 to the next switching.

Further, the stress value calculation unit 22 calculates an average of the loads (stress values) indicated by the stress data included in the work time from the switching of the active window 40 to the next switching as a representative value. As a result, the analyst may perform an analysis using the average value of stress in the work time of the same work type from the switching of the active window 40 to the next switching.

Further, the stress value calculation unit 22 calculates a difference between the load (stress value) indicated by the stress data at the start of the work time from the switching of the active window 40 to the next switching, and the load (stress value) indicated by the stress data at the end of the work time, as a representative value. As a result, the analyst may perform an analysis using the difference in stress from the start to the end of the work time of the same work type from the switching of the active window 40 to the next switching.

Further, the stress value calculation unit 22 calculates a regression coefficient based on the load (stress value) indicated by the stress data included in the work time from the switching of the active window 40 to the next switching, as a representative value. As a result, the analyst may perform an analysis using the regression coefficient corresponding to the fluctuation of stress, such as the slope of the regression curve of the stress value in the work time of the same work type from the switching of the active window 40 to the next switching.

In addition, each component of each of the illustrated devices does not necessarily have to be physically configured as illustrated. That is, the specific forms of distribution and integration of respective devices are not limited to those illustrated in the drawings, but all or a part thereof may be distributed or integrated functionally or physically in arbitrary units according to various loads, usage situations, or the like.

For example, in the present embodiments (the first embodiment and the second embodiment), the client terminal 1 is illustrated as an information processing apparatus on which the subject 5 is working, but the information processing apparatus on which the subject 5 is working may be a PC or tablet terminal different from the client terminal 1. Further, although the present embodiment illustrates a client-server configuration in which the client terminal 1 and the server 2 are separated, the client terminal 1 may be, for example, a stand-alone configuration having a functional configuration on the server 2.

Further, in the present embodiments, a configuration is illustrated in which representative values of loads (stress values) indicated by stress data in the same work type period are associated and stored in the database 25, but the stress data for the same work type period may be associated and stored as it is. In this case, for example, when the stress data is aggregated by the analyst terminal 3 or the like, the above representative value may be obtained.

Further, all or any part of various processing functions performed by the client terminals 1 and 1a, the servers 2 and 2a, and the analyst terminal 3 of the evaluation system 100 may be performed on the CPU (or a microcomputer such as an MPU or an MCU (Micro Controller Unit)). In addition, it is needless to say that all or any part of the various processing functions may be performed on a program analyzed and executed by a CPU (or a microcomputer such as an MPU or an MCU) or on hardware by wired logic. Further, the various processing functions performed by the client terminals 1 and 1a, the servers 2 and 2a, and the analyst terminal 3 may be performed by a plurality of computers in cooperation by cloud computing.

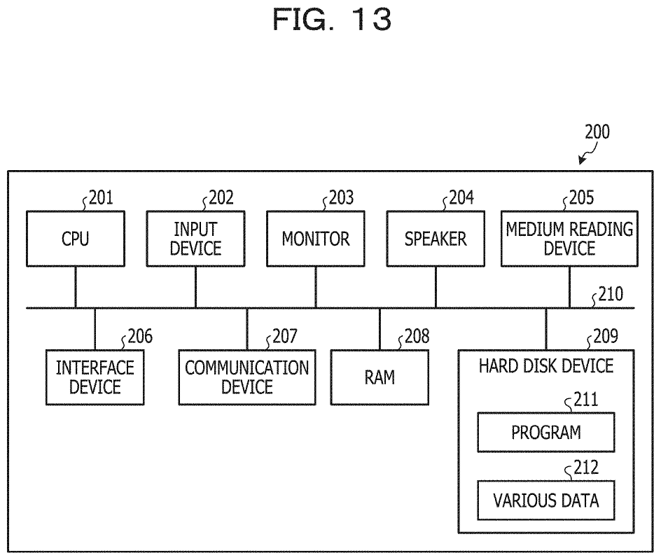

Meanwhile, various processes described in the above embodiments may be implemented by executing a program prepared in advance on a computer. Therefore, descriptions will be made below on an example of a computer configuration (hardware) that executes a program having the same function as that of the above embodiments. FIG. 13 is a block diagram illustrating an example of a computer configuration.

As illustrated in FIG. 13, the computer 200 includes a CPU 201 that executes various arithmetic processes, an input device 202 that receives data input, a monitor 203, and a speaker 204. Further, the computer 200 includes a medium reading device 205 for reading a program or the like from a storage medium, an interface device 206 for connecting to various devices, and a communication device 207 for communicating with an external device by either a wired or wireless communication. Further, the client terminal 1 includes a RAM 208 for temporarily storing various information and a hard disk device 209. Also, each part (201 to 209) in the computer 200 is connected to a bus 210.

The hard disk device 209 stores a program 211 for executing various processes in the functional configuration described in the above embodiments (e.g., the data reception unit 20, the time association unit 21, the stress value calculation unit 22, the tagging unit 23, and the database storage unit 24). Further, the hard disk device 209 stores various data 212 referred to by the program 211. The input device 202 receives, for example, input of operation information from an operator. The monitor 203 displays, for example, various screens operated by the operator. For example, a printing device or the like is connected to the interface device 206. The communication device 207 is connected to a communication network such as a LAN (Local Area Network) to exchange various information with an external device via the communication network.

The CPU 201 reads the program 211 stored in the hard disk device 209, expands the program 211 into the RAM 208, and performs various processes related to the above-mentioned functional configurations (e.g., the data reception unit 20, the time association unit 21, the stress value calculation unit 22, the tagging unit 23, and the database storage unit 24). Further, the program 211 may not be stored in the hard disk device 209. For example, the computer 200 may be caused to read and execute the program 211 stored in a readable storage medium. The storage medium that is readable by the computer 200 corresponds to, for example, a CD-ROM, a DVD disk, a portable recording medium such as a USB (Universal Serial Bus) memory, a semiconductor memory such as a flash memory, a hard disk drive, or the like. Further, the program 211 may be stored in a device connected to a public line, the Internet, a LAN, or the like, and the computer 200 may be caused to read the program 211 from these and execute the program 211.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored an evaluation support program that causes a computer to perform a process, the process comprising:
acquiring load information that indicates a load of a subject;
acquiring information of an active window of an information processing apparatus on which the subject is working;
classifying a type of work, based on the acquired information of the active window; and
storing a classification result of the classifying of the type of work, the acquired load information, and time information that indicates acquisition time of the load information in association with each other as information related to a work evaluation of the subject.

2. The non-transitory computer-readable recording medium according to claim 1, wherein, in the classifying of the type of work, the type of work is classified based on keywords included in the acquired information of the active window.

3. The non-transitory computer-readable recording medium according to claim 2, wherein, in the classifying of the type of work, the type of work is classified based on a type of application related to the active window acquired in the acquiring of the information of the active window.

4. The non-transitory computer-readable recording medium according to claim 3, wherein, in the classifying of the type of work, the type of work is classified into a plurality of layers based on a combination of the keywords included in the acquired information of the active window and the type of application related to the active window acquired in the acquiring of the information of the active window.

5. The non-transitory computer-readable recording medium according to claim 1,
wherein, in the acquiring of the information of the active window, the information of the active window after switching is acquired according to switching of the active window, and
wherein, in the storing of the classification result, the classification result based on the information of the active window after switching, the load information acquired during a period from the active window after switching to a next active window, and time information of the acquired period are stored in association with each other.

6. The non-transitory computer-readable recording medium according to claim 5, the process further comprising:
calculating a representative value of the load information acquired in the period, and
wherein, in the storing of the classification result, the classification result, the calculated representative value, and the time information of the acquired period are stored in association with each other.

7. The non-transitory computer-readable recording medium according to claim 6,
wherein, in the calculating of the representative value, an average of loads indicated by the load information acquired in the period is calculated as the representative value.

8. The non-transitory computer-readable recording medium according to claim 6,
wherein, in the calculating of the representative value, a difference between a load indicated by the load information at a start of the period and a load indicated by the load information at an end of the period is calculated as the representative value.

9. The non-transitory computer-readable recording medium according to claim 6,
wherein, in the calculating of the representative value, a regression coefficient based on a load indicated by the load information acquired in the period is calculated as the representative value.

10. An evaluation support method that causes a computer to execute a process, the process comprising:
acquiring load information that indicates a load of a subject;
acquiring information of an active window of an information processing apparatus on which the subject is working;
classifying a type of work, based on the acquired information of the active window; and
storing a classification result of the classifying of the type of work, the acquired load information, and time information that indicates acquisition time of the load information in association with each other as information related to a work evaluation of the subject.

11. The evaluation support method according to claim 10, wherein, in the classifying of the type of work, the type of work is classified based on keywords included in the acquired information of the active window.

12. The evaluation support method according to claim 11, wherein, in the classifying of the type of work, the type of work is classified based on a type of application related to the active window acquired in the acquiring of the information of the active window.

13. The evaluation support method according to claim 12, wherein, in the classifying of the type of work, the type of work is classified into a plurality of layers based on a combination of the keywords included in the acquired information of the active window and the type of application related to the active window acquired in the acquiring of the information of the active window.

14. The evaluation support method according to claim 10,
wherein, in the acquiring of the information of the active window, the information of the active window after switching is acquired according to switching of the active window, and
wherein, in the storing of the classification result, the classification result based on the information of the active window after switching, the load information acquired during a period from the active window after switching to a next active window, and time information of the acquired period are stored in association with each other.

15. The evaluation support method according to claim 14, the process further comprising:
calculating a representative value of the load information acquired in the period, and
wherein, in the storing of the classification result, the classification result, the calculated representative value, and the time information of the acquired period are stored in association with each other.

16. The evaluation support method according to claim 15,
wherein, in the calculating of the representative value, an average of loads indicated by the load information acquired in the period is calculated as the representative value.

17. The evaluation support method according to claim 15,
wherein, in the calculating of the representative value, a difference between a load indicated by the load information at a start of the period and a load indicated by the load information at an end of the period is calculated as the representative value.

18. The evaluation support method according to claim 15,
wherein, in the calculating of the representative value, a regression coefficient based on a load indicated by the load information acquired in the period is calculated as the representative value.

19. An information processing apparatus comprising:
a memory; and
a processor coupled to the memory and configured to:
acquire load information that indicates a load of a subject;
acquire information of an active window of an information processing apparatus on which the subject is working;
classify a type of work, based on the acquired information of the active window; and
store a classification result of the classifying of the type of work, the acquired load information, and time information that indicates acquisition time of the load information in association with each other as information related to a work evaluation of the subject.

20. The information processing apparatus according to claim 19,
wherein the processor is configured to:
acquire the information of the active window after switching according to switching of the active window, and
store, in association with each other, the classification result based on the information of the active window after switching, the load information acquired during a period from the active window after switching to a next active window, and time information of the acquired period.
